(19) United States
(12) Patent Application Publication
(10) Pub. No.: US 2006/0222745 A1
(43) Pub. Date: Oct. 5, 2006

(54) Method for preventing the transfer of water

(75) Inventors: Johannes Baumer, Lontzen (BE); Juergen Becker, Alsdorf (DE); Dominik Heisterueber, Eschweiler (DE); Dietmar Otte, Aachen (DE)

Correspondence Address: WILLIAM COLLARD;COLLARD & ROE, P.C., 1077 NORTHERN BOULEVARD, ROSLYN, NY, 11576, US

(73) Assignee: Franz ZENTIS GmbH & Co. KG

(21) Appl. No.: 11/394,047

(22) Filed: Mar. 30, 2006

(30) Foreign Application Priority Data
Mar. 31, 2005 (DE) 10 2005 015 131.0

(51) Int. Cl. A23G 3/20

(52) U.S. Cl. 426/306

(57) ABSTRACT

A method is disclosed for preventing the transfer of water from a water-containing foodstuff into a particle, a particle for the joint consumption with a water-containing foodstuff and a fruit preparation for joint consumption with a dairy product. In order to reduce the requirements placed on the storage of water-absorbing particles, the particles, prior to the introduction into the foodstuff, are covered completely with an inner layer made of chocolate and thereafter with an outer layer made of fat, and the particle includes two closed covers applied onto each other made of chocolate and fat, respectively. Also disclosed is a fruit preparation laced with such particles.

### CROSS REFERENCE TO RELATED APPLICATIONS

Applicants claim priority under 35 U.S.C. §119 of German Application No. 10 2005 015 131.0 filed Mar. 31, 2005.

### BACKGROUND OF THE INVENTION

1. Field of the Invention

The invention relates to a method for preventing the transfer of water from a water-containing foodstuff into a particle, with the particle being coated completely with fat prior to the introduction into the foodstuff. The invention further relates to a particle for joint consuming with a water-containing foodstuff and further a fruit preparation for joint consuming with a dairy product.

2. The Prior Art

The object of introducing particles of a large variety into water-containing foodstuffs places high demands on foodstuff chemistry and technology. The use of particles for example which have a porous structure and absorb water in the manner of a sponge with water-containing preparations are subject to narrow limits. Cereal-based particles in the form of full squashed grains (e.g. so-called “oatmeal”, puffed grain such as “puff rice”, coarsely ground cereals and cereal flour preparations in roasted form for example as “cornflakes” and other extruded products) will swell upon contact with water-containing media within a short period of time and thus lose their typical “crunchiness”.

Even other particles with water-soluble components such as sugar in particular or such with swelling components (e.g. parts of plants, especially dried pieces of fruit such as sultanas or banana chips, and also nuts and pieces of nuts) will absorb humidity from an ambient water-containing medium (and even from ambient air) and are therefore suitable for storage in a water-containing foodstuff only under very stringent conditions. Generally, the joint use of components with very different water content (e.g. cereal extrudates with a water content of 3 to 6% in yoghurts with a water content of over 70%) is only possible within narrow limits.

It is generally known to principally store water-absorbing particles in a dry way, to supply the same to the water-containing preparation only shortly before consumption in order to prevent the transfer of water from the preparation into the particles as long as possible. In similarly generally known sales packages for foodstuffs with such particles, the water-containing preparation and the particles are stored in chambers which are separated from each other in a waterproof manner. For example, puff rice for consumption with a pudding preparation is additionally stored in a transparent lid clipped onto the cup. It is also known to store chocolate particles which contain a high amount of sugar in a second cup which is joined to the first cup and, for the joint consumption of the dairy product with the particles, is tipped onto the first one and is thus emptied.

The known methods especially do not provide any possibility to add particles which absorb liquid from the ambient environment to fruit preparations which are produced in the known manner as intermediate products for the production of mixed dairy products (e.g. fruit yoghurt).

The German utility model G 92 07 601 U1 describes the separation of a mass of hydrophilic grainy particles from a fresh milk product, with such separation being achieved by a layer of fat formed between the two. The utility model describes that at least individual particles are also incorporated in the fat layer. Within the scope of the incorporation of a particle in a fat layer, the same is fully enclosed by fat. The mobility of individual particles relative to one another is provided as little after the incorporation as the possibility of dosing the particles by pouring. By arranging the particles within a fat layer, the production of a homogeneous mixture of particles and the milk product is hardly possible even prior to consumption.

DE 40 17 114 A1 discloses the spraying of a closed fat layer onto a cereal germ product. This is intended to reduce the loss of relevant ingredients during the storage and extend the storage life of the cereal germs. Storage-stable fats and/or oils of saturated fatty acids with a melting point under 35° C. are to be used for hydrophobing the cereal germs. The specification describes cocoa butter, coconut fat or soft sunflower fat as being especially suitable due to the pleasant sensation in the mouth thus provided. The disadvantage in the known procedure is that the thus treated cereal germs are not especially appealing from the viewpoint of taste because the used fats do not lead to any positive taste sensations apart from the pleasant feeling in the mouth.

U.S. Pat. No. 4,310,560 describes a method for producing particles from a cereal extrudate. The particles produced according to the known methods are to be used in a water-containing foodstuff such as a dessert for example. For protecting the particle against the influence of water, its porous outer surface is provided with a coating of an edible fat which is solid under normal conditions. Particles are to maintain their crunchiness for a period of at least 60 minutes in a hydrous medium. As a result of the porous surface a complete hermetical sealing of the surface of the particle is hardly possible. A very large quantity of fat would then have to be used, which would lead to disadvantages in the taste of the particles because the fats, especially when present in larger quantities in the particle, will make their presence felt by a far from pleasant taste.

### SUMMARY OF THE INVENTION

The invention is based on the object of reducing the requirements placed on the storage of water-absorbing particles and to provide particles with an attractive taste.

It is proposed in accordance with the invention that within the scope of a method in accordance with the invention the particle, prior to the introduction into the foodstuff, is covered at first with an inner layer of chocolate and thereafter with an outer layer of fat. The application of a closed outer cover of fat which is impermeable for water not only effectively prevents the transfer to water from a water-containing medium (especially the foodstuff), but also prevents the penetration of water into the chocolate layer situated beneath the fat layer. The two-layer configuration further generally allows the state of the particle prior to its application (especially the crunchiness of a dried particle) to be maintained irrespective of the ambient medium and offers at the same time the pleasant flavorful properties of the chocolate.

On the other hand, the outer cover applied in accordance with the invention also prevents the transfer of components of the particle into the foodstuff. For example, vitamins, minerals (e.g. iron) and roughage and colorings from the chocolate are kept apart from the water-containing foodstuff and undesirable effects (such as the promotion of oxidative processes by iron such as the milk fat becoming rancid or the browning or coloring foodstuffs) are effectively prevented.

The requirements placed on the storage of the particles covered twice in accordance with the invention are reduced significantly by this measure. It is thus enabled to mix the particles directly into a water-containing foodstuff in the sales packet for the end customer.

Chocolate within the terms of this application shall not only be understood as the foodstuff composition as defined in the cocoa decree, but also all other mixtures of cocoa components, fat and sugar or alternative sweeteners. It is possible to use instead of cocoa butter other equivalent or substitute fats (e.g. CBE=Cocoa Butter Equivalent, CBS=Cocoa Butter Substitute) which are generally known. A big advantage of the outer fat coating in accordance with the invention around the chocolate layer is that thus the use of a chocolate with a high share of sugar is enabled. Whereas known chocolates determined for use in hydrous media have a very high share of fat and a very low share of sugar and therefore taste rather bitter and are therefore mostly used in a sweet environment compensating this bitter taste, the particles produced in accordance with the inventive method can also be used in combination with a slightly sour, slightly sweetened or unsweetened foodstuff (e.g. natural yoghurt) because the chocolate can easily have the recipe typical for conventional milk chocolate for example which has a comparatively high content of sugar. Whereas regular milk chocolate cannot be stored in hydrous foodstuffs because swelling and decoloring effects occur very rapidly, the fat cover in accordance with the invention allows such a storage.

The fat of the outer layer is solid at room temperature (approx. 20° C. to 25° C.), but at least at storage temperature (approx. 4° C. to 8° C.) of the particle or of the foodstuff containing the same, e.g. yoghurt.

In an especially preferred embodiment of the method in accordance with the invention, the fat is a vegetable fat and has a melting point similar to cocoa butter. Such fats, which are known for example as “CBE” (cocoa butter equivalent) or “CBR” (cocoa butter replacer) or “CBS” (cocoa butter substitute), are soft and free-flowing at 20 to 25° C. and slightly elastic at conventional refrigerator temperatures. Solid fats require processing at higher temperatures on the one hand. On the other hand, they form very hard structures under refrigerator temperatures and fracture like glass under load. The above fats which are similar to cocoa butter in their melting behavior are capable of compensating without any damage extensions and shrinkages of the covered particles even in a thin layer. CBS fats on the basis of coconut oil are preferable to palm-oil-based CBR or CBE fats due to more favorable tasting sensation and for cost reasons.

Furthermore, a porous structure of the particle is smoothed on its surface at first by application of the inner layer of chocolate preferably within the scope of the method in accordance with the invention before the outer layer of fat is applied. In addition to the improvement in the flavor of the particles, the covering with chocolate also compensates any unevenness in the surface of the particle up to the filling of open pores without increasing the thickness of the fat layer. Whereas a use of the inner chocolate layer is possible in larger quantities without any impairment to the taste, this is not the case with the outer fat layer because the fat might have a disadvantageous effect on the taste when used in larger quantities. Moreover, a soft chocolate (e.g. plain chocolate with a high share of cocoa butter or milk chocolate with a high share of milk fat) can be used within the scope of the method in accordance with the invention, which on its part forms in its capacity as a shrinkage layer a buffer between the different expansions and shrinkages of particles and the enclosing fat cover.

The method in accordance with the invention can be used especially advantageously when the foodstuff is a semi-finished good from which a product determined for the end consumer is produced in further processing steps. Such semi-finished goods are especially preparations which are added in small quantities to dairy products for setting special sensory properties, e.g. fruit preparations.

The invention is further formed by particles for joint consumption with a water-containing foodstuff with a closed inner layer of chocolate applied to the surface of the uncoated particle and a closed outer layer of fat, as have been applied by the method in accordance with the invention as described above, and especially by particles which have a porous structure at least on their surface prior to the coating. The requirements placed on storage capability of such particles in accordance with the invention (especially dry ones) is significantly reduced as compared with the known particles.

The application of the method in accordance with the invention allows lacing a fruit preparation with such particles, which preparation is added to a dairy product for producing a mixed dairy product for joint consumption with the same.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawing, wherein similar reference characters denote similar elements throughout the several views:

FIG. 1 shows a sectional view through a particle in accordance with the invention, and

FIG. 2 shows a schematic representation of said sectional view.

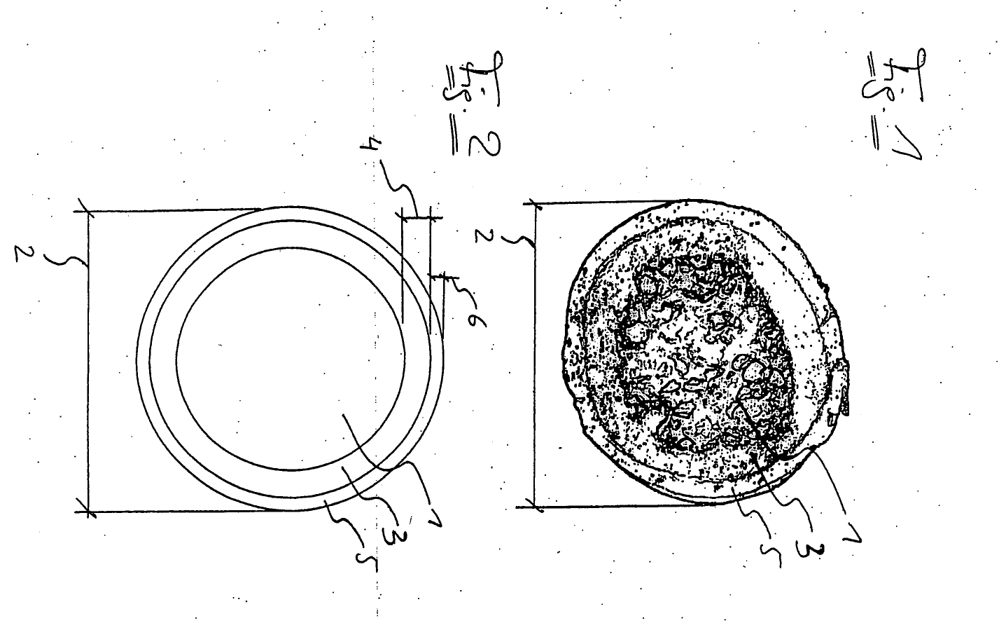

### DETAILED DESCRIPTION OF PREFERRED EMBODIMENTS

The particle 1 in accordance with the invention which is shown in the drawings is a porous, but crunchy, sand-colored, spherical extrudate on the basis of a cereal, e.g. on the basis of wheat or rice, a so-called “wheat-rice crisp” with a typical cereal smell and of a slightly sweet taste. Particle 1 has a diameter 2 of 3 mm to 4 mm and an apparent weight of 265 g/l. In order to achieve a shelf life of at least 12 months, the particle 1 shall be stored in a cool way according to manufacturer's specifications, namely at a storage temperature of below 20° C. and with less than 65% humidity and protected from light. The surface of the particle is porous and comprises a plurality of irregularly shaped and differently large cavities or caverns which are open towards the outside.

Particle 1 comprises a first (inner) layer 3 made of chocolate, which is a so-called “plain chocolate” with a content of approx. 45% sugar, 16% cocoa powder and 33% cocoa butter and has a thickness 4 of approx. 0.35 mm, measured from the imaginary enveloping surface of the irregular surface, i.e. the depth of cavity or caverns that might be filled with chocolate are not measured. The chocolate applied in liquid form fills cavities that are on the face of the surface and thus smoothes its surface.

Particle 1 comprises a closed second (outer) layer 5 made of fat with a thickness 6 of approx. 0.4 mm outside of the layer 3 made of chocolate. The fat is a pure vegetable CBE fat with the main component of palm oil. The solid fat content (SFC) is approx. 70% at 20° C. and approx. 30 to 40% at 30° C.; slip melt point (mod. DGF method C IV 3a, WRMA 4) is close to 33 to 35° C. The melting behavior of the fat and the mentioned alternatives is similar to the melting behavior of cocoa butter.

In addition to the purely sensory function of the chocolate, the first layer 3 also fulfils further functions: The smoothed and closed surface (as compared with the original crisp) allows a considerably more even coating of the particle 1 with the fat which is liquid in the coating process and thus allows a minimization of the thickness 6 of the second layer 5 up to a value which allows the fat to retreat in the sensory overall impression relative to the chocolate (or any other interior component which has a sensory effect). Moreover, the chocolate acts as an elastic “buffer zone” and compensates various temperature-induced expansions and shrinkages from the fat situated on the outside and the particle 1 situated on the inside.

The particle 1 in accordance with the invention is added in a proportion of approximately 15 to 25% of a preparation, e.g. with the flavors vanilla, chocolate, stracciatella, banana, orange, pear, muesli, which are joined in a sales container to a dairy product such as natural yoghurt, curd or a pudding. Even after a longer storage period the particles 1 still show their original crunchiness despite the hydrous environment, which is a complete novelty in comparison with current products with separate particle storage.

Although at least one embodiment of the present invention has been shown and described, it is to be understood that many changes and modifications may be made thereunto without departing from the spirit and scope of the invention as defined in the appended claims.

What is claimed is:

1. A method for preventing the transfer of water from a water-containing food stuff into a particle introduced into the foodstuff for joint consumption of the particle with the foodstuff comprising the following steps:
(a) coating a particle to be introduced with a first layer of chocolate;
(b) subsequently coating the particle completely with a second layer of fat to form a coated particle with the first layer forming an inner layer and the second layer forming an outer layer; and
(c) introducing the coated particle into the foodstuff.

2. The method according to claim 1, wherein the fat is a vegetable fat and has a melting point similar to cocoa butter.

3. The method according to claim 1, wherein the particle initially has a porous structure and application of the inner layer made of chocolate smoothes a surface of the particle before the outer layer of fat is applied.

4. A method according to claim 1, wherein the foodstuff is a semi-finished good.

5. A particle for joint consumption with a water-containing foodstuff comprising
(a) a closed inner layer made of chocolate; and
(b) a closed outer layer made of fat applied on said inner layer.

6. The particle according to claim 5, wherein the particle has a porous structure at least on a surface of the particle prior to application of the inner layer.

7. A first preparation for joint consumption with a dairy product comprising:
(a) a preparation; and
(b) a plurality of particles laced in the preparation, each particle comprising a closed inner layer made of chocolate and a closed outer layer made of fat applied on the inner layer.

8. The fruit preparation according to claim 7 wherein each particle has a porous structure at least on a surface of the particle prior to application of the inner layer.
